(19) United States
(12) Patent Application Publication
(10) Pub. No.: US 2014/0116953 A1
(43) Pub. Date: May 1, 2014

(54) METHOD FOR OBTAINING METAL-CONTAINING VALUABLE SUBSTANCES FROM A SUSPENSION-LIKE MASS FLOW THAT CONTAINS METAL-CONTAINING VALUABLE SUBSTANCES

(71) Applicants: Stefan Blendinger, Fürth (DE); Robert Fleck, Adelsdorf (DE); Gerold Franke, Nürnberg (DE); Lilla Grossmann, Erlangen (DE); Werner Hartmann, Weisendorf (DE)

(72) Inventors: Stefan Blendinger, Fürth (DE); Robert Fleck, Adelsdorf (DE); Gerold Franke, Nürnberg (DE); Lilla Grossmann, Erlangen (DE); Werner Hartmann, Weisendorf (DE)

(73) Assignee: SIEMENS AKTIENGESELLSCHAFT, München (DE)

(21) Appl. No.: 14/124,915

(22) PCT Filed: May 24, 2012
(86) PCT No.: PCT/EP2012/059699

§ 371 Date: Dec. 9, 2013

(30) Foreign Application Priority Data
Jun. 7, 2011 (DE) 10 2011 077 104.2

(51) Int. Cl. B03D 1/02; B03D 1/24

(52) U.S. Cl. CPC B03D 1/02; B03D 1/24
USPC 210/703; 261/21

(57) ABSTRACT

A method obtains metal-containing valuable substances from a suspension that contains metal-containing valuable substances. A corresponding suspension which is pressurized after passing through at least one pump device and which is mixed with a gas is fed to at least one jet device of at least one flotation cell via at least one feed line. The metal-containing valuable substances are separated in the at least one flotation cell. The suspension that contains the metal-containing valuable substances is charged with gas at least partially after passing through the pump device before entering the jet device.

### CROSS REFERENCE TO RELATED APPLICATIONS

This application is based on and hereby claims priority to International Application No. PCT/EP2012/059699 filed on May 24, 2012 and German Application No. 10 2011 077 104.2 filed on Jun. 7, 2011, the contents of which are hereby incorporated by reference.

### BACKGROUND

The invention relates to a method for obtaining metal-containing valuable substances from a suspension-like mass flow that contains metal-containing valuable substances.

Flotation methods for obtaining or preparing metal-containing valuable substances from a suspension-like mass flow that contains metal-containing valuable substances, i.e. by way of example ores from a pulp containing an ore, are widely known. The valuable substances contained in the pulp are separated by binding them to a gas fed into the pulp. The valuable substance particles, optionally hydrophobized with a hydrophobing agent, such as xanthate, accumulate on the gas bubbles and can be removed with the foam which collects on the surface of the flotation cell.

In the case of what are known as hybrid cells, in which a pneumatic and a column cell are combined, two zones are produced in which one corresponding foam forms respectively. Mainly the fine fraction of the valuable substance particles is conventionally removed in the pneumatic cell. The coarse fraction of the corresponding valuable substance particles is also removed in the column cell.

The gas is, as a rule, introduced via a jet device, for instance in the form of a multi-stage ejector, by way of which the mass flow containing the valuable substances is introduced into the flotation cell.

It is known in this connection to convey the mass flow containing the valuable substances under pressure, i.e. pre-pressurized, through the jet device to increase the solubility for gases. To produce fine gas bubbles high shear forces are generated in a mixer associated with the jet device, so the fed gas is “torn” into individual bubbles. The high flow speeds required for this necessitate a high pressure in the flow of water, for which reason this regularly passes through a pump device in advance.

However, the dwell time of the gas in the mixer associated with the jet device, and therewith the possibility of physically dissolving to a considerable degree, is very low. The approaches known from the related art for producing a finely distributed gas bubble profile in a mass flow containing corresponding metal-containing valuable substance are therefore not satisfactory.

### SUMMARY

One possible goal is improving the production of finely distributed gas bubbles in a mass flow to be fed to a flotation cell.

The inventors propose a method for obtaining metal-containing valuable substances from a suspension-like mass flow that contains metal-containing valuable substances, wherein a corresponding mass flow which is pressurized after passing through at least one pump device and which is mixed with a gas is fed to at least one jet device of at least one flotation cell via at least one feed line, wherein the metal-containing valuable substances are separated in the at least one flotation cell. According to the inventors' proposal, the gas charging of the mass flow containing the metal-containing valuable substances occurs at least partially after passing through the pump device and before entrance of the mass flow into the jet device.

The proposed method and provides that the gas is fed as early as upstream of the jet device, via which the pressurized mass flow is introduced, in particular tangentially, into the flotation cell. The gas therefore has more time to mix with the pressurized mass flow, to distribute itself homogeneously therein and form fine gas bubbles. Air and/or nitrogen by way of example can be used as the gas. The fed gas is advantageously also pressurized itself, i.e. is fed under pressure.

Basically the aim is therefore to give the gas as much time as possible to distribute itself in the mass flow while forming fine gas bubbles, so it is preferred if the gas is added as soon as possible after leaving the pump device, for which reason the mass flow is mixed with the gas directly after leaving the pump device in a preferred embodiment. A maximum dwell time of the gas in the mass flow is therefore possible, and this promotes the formation of fine and well-distributed gas bubbles when the gaseous mass flow expands after leaving the jet device, i.e. on entering the flotation cell.

The inventors' proposals therefore allow an increase in the total bubble surface area and a more homogeneous distribution of the gas bubbles in the flotation cell.

Compared with the related art, more simply designed, optionally even single-stage, jet devices may optionally be used as a result, since the division of the gas bubbles occurs for the most part in the mass flow. Furthermore, the inventors' proposals allow the use of lower pressures since, compared with the related art, lower shear rates are required in the jet device, and this likewise reduces the wear on the jet device and the energy consumption of the pump device connected upstream of it.

The diameters of the gas bubbles required for the flotation cell are by way of example in a range from 0.1 mm to 1 mm and can be achieved without problems by the inventors' proposals.

The inventors' proposals make use of the principle that a pressurized mass flow can absorb or physically dissolve more gas than a non-pressurized mass flow. This can be illustrated with reference to the following example. Relative to a kilogram of water, about 20 mg air can be physically dissolved at an ambient pressure of about 1 bar and a temperature of about 20° C. If the pressure is increased to 5 bar, 110 mg air can already be dissolved in the same volume and under otherwise identical conditions.

In the case of a corresponding mass flow containing metal-containing valuable substances and with a solids fraction of 50%, about 10% of the gas flow dissolves in the mass flow with a typical ratio of mass flow to gas flow of 2:1 and a pressure of about 4.5 bar. It is therefore preferred that at least 10% of the total volume of gas to be fed to the mass flow is fed before entry of the mass flow into the jet device.

Basically the aim is, however, to add the entire volume of gas to be fed to the mass flow upstream of the jet device. However, it is also possible for instance, as known, to feed some of the total volume of gas to be fed to the mass flow directly via the jet device.

It may also be that the mass flow is also mixed with the gas before entering the pump device. This is especially advantageous since, in addition to increasing the pressure, the pump device performs a mixing as it were of the gas with the mass flow. The therefore intensive mixing of the mass flow with the gas leads to the formation of fine gas bubbles. One pre-requirement, however, is the use of a suitable pump device, i.e. a pump device which allows conveying of gas.

The gas is advantageously fed via a blowing device connected to the feed line between the pump device and the jet device. The blowing device can by way of example include a plurality of jets via which the gas is fed or blown into the feed line. An optimally uniform distribution of the gas over the cross-section of the feed line and an increase in the bubble surface area can achieved hereby.

To improve the physical dissolving of the gas in the mass flow, in particular by way of an extended dwell time of the gas in the mass flow, still further, basically lower flow speeds of the mass flow are desired. The mass flow therefore preferably flows through the feed line at a speed in the range of 0.5 to 5 m/s, preferably 0.75 to 3 m/s, in particular 1 m/s.

With the same aim it may alternatively or additionally be provided that the length of the feed line is extended between the pump device and the jet device.

It is expedient to use a centrifugal pump as the pump device. Centrifugal pumps allow good mixing of gas and mass flow, in particular they also allow gas conveying, so the use of appropriate centrifugal pumps lends itself in particular to the embodiment, according to which the mass flow is also mixed with the gas before entering the pump device.

The inventors also propose a device for carrying out the method described above. The device has at least one pump device and at least one flotation cell, connected to the pump device via at least one feed line, for separating metal-containing valuable substances from a mass flow containing metal-containing valuable substances. At least one jet device is arranged between the feed line and the flotation cell.

The device is characterized in that at least one blowing device for blowing a gas into the feed line is arranged between the pump device and the jet device. Longer dwell times of the gas fed via the blowing device, which can comprise a plurality of jets, are therefore possible with the device, and this leads to the formation of finer and more homogeneously distributed gas bubbles, which are required within the framework of corresponding flotation methods.

A particularly long dwell time of the gas in the mass flow results if the blowing device is arranged immediately after the pump device.

It is conceivable for at least one additional blowing device to be arranged on a line section upstream of the pump device. In this embodiment of the device the gas can therefore be fed to the mass flow at two locations at least, i.e. upstream of the pump device and downstream of the pump device. This embodiment is particularly expedient if the pump device allows gas conveying, as is the case for example with centrifugal pumps.

It is also possible for at least one additional blowing device to be arranged on the jet device. The arrangement of an appropriate blowing device on the jet device itself allows an additional feed of gas immediately before entering the flotation cell.

In the case of several blowing devices a distributor, which communicates with the respective blowing devices, can be connected upstream of them, and this is designed to distribute a gas flow among the corresponding blowing devices. The distributor allows a targeted flow of gas to the blowing devices. The blowing devices can each be supplied with the same flows of gas or individual ones, i.e. flows of gas which are different for example with regard to a pressurization of the flows of gas.

A detector which communicates with the distributor is advantageously provided for detecting the size of the gas bubbles flowing inside the feed line, wherein the gas flow is distributed among the corresponding blowing devices as a function of the result of detection. The detector can for instance comprise optical measuring instruments by way of which detection of the size and/or distribution of the gas bubbles in the mass flow is/are possible. The measuring instruments can be arranged at different locations in the feed line to the jet device, so various measured values are obtained along the feed line and a size and/or distribution of the gas bubbles in the flow of water can be detected in this way, and in particular continuously. Corresponding measuring instruments can also be provided in the line section upstream of the pump device and optionally on the jet device as a function of the number and arrangement of the corresponding blowing devices.

Appropriate gases can flow by way of the distributor via the respective blowing devices as a function of the result of detection. If, by way of example, it is detected that there is still a relatively low number of fine gas bubbles in the mass flow just upstream of the jet device, a blowing device arranged at the jet device side can be switched on, so additional gas flows into the jet device and in particular under high pressure.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic diagram of a device according to a first exemplary embodiment of the inventors' proposals, and

FIG. 2 shows a schematic diagram of an device according to a second exemplary embodiment.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

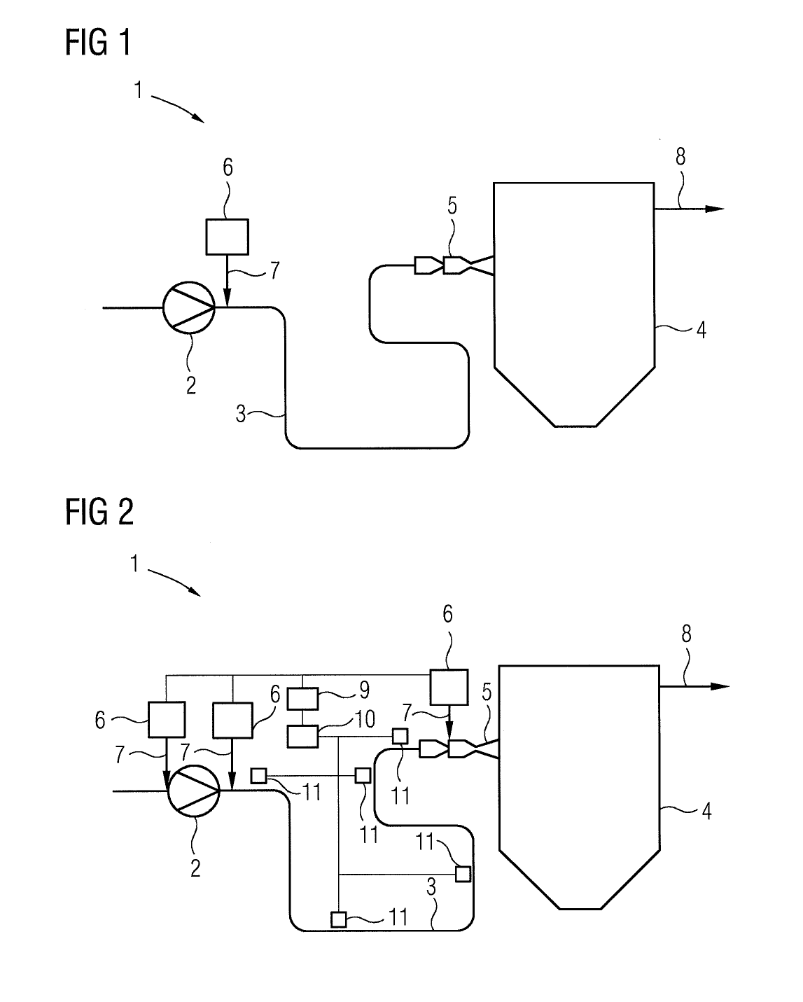

FIG. 1 shows a schematic diagram of an device 1 according to a first exemplary embodiment. The device 1 has a pump device 2, for instance in the form of a centrifugal pump, and a flotation cell 4, connected by a feed line 3 to the pump device 2, for separating metal-containing valuable substances from a mass flow, such as an ore-containing pulp or the like, containing metal-containing valuable substances. A jet device 5 in the sense of an ejector is connected upstream of the flotation cell 4, via which jet device 5 the mass flow is fed tangentially into the flotation cell 4. The feed line 3 ends in the jet device 5.

A first blowing device 6 for blowing (cf. arrow 7) a gas, i.e. in particular air or nitrogen, into the feed line 3 is arranged between the pump device 2, which pressurizes the mass flow, and the jet device 5. The gas fed into the pressurized mass flow flowing in the feed line 3 allows binding of the, optionally hydrophobized, metal-containing valuable substances, so after exiting from the jet device 5 these accumulate in the form of a foam on the surface of the flotation cell 4 and can be removed at this location (cf. arrow 8).

To allow an optimally long dwell time of the gas fed via the blowing device 6 in the feed line 3 and therefore allow good mixing of the gas with the valuable substance particles contained in the mass flow, the blowing device 6 is connected immediately downstream of the pump device 2. This means substantially the entire length of the feed line 3 is available for formation of the gas bubbles, or rather mixing of the gas bubbles with the metal-containing valuable substances. The length of the feed line 3 can optionally be extended beyond the conventionally required size, so a longer dwell time of the gas in the mass flow is likewise enabled, and this results from the longer distance which the gas has to cover by comparison. An increase in the volume of gas which can be physically dissolved in the mass flow can be achieved due to the feeding of gas into the pressurized mass flow.

For the same purpose the flow speed of the gas-charged mass flow is regulated to about 1 m/s. This means low flow speeds are preferably sought. The flow speed of the mass flow can be adjusted for instance by way of the power of the pump device 2, i.e. the pressure of the mass flow.

The dissolved gas, in particular when exiting the jet device 5 or when entering the flotation cell 4, and therefore with a reduction in pressure, forms fine, homogeneously distributed gas bubbles. The available free gas bubble surface area can accordingly be increased and be distributed more uniformly in the flotation cell 4. The efficiency of the flotation cell 4, and therefore of the method overall, can be increased in this way.

Preferably at least 10% of the total volume of gas to be fed to the mass flow as a whole are fed into the jet device 5 before entry of the mass flow.

FIG. 2 shows a schematic diagram of an device 1 according to a second exemplary embodiment. The fundamental difference from the embodiment shown in FIG. 1 is that a plurality of blowing devices 6 belong to the device 1, i.e. in particular one blowing device 6 is additionally provided in a line section upstream of the pump device 2 and a further blowing device 6, which is arranged directly on the jet device 5, is provided. It is therefore possible here to feed corresponding flows of gas to three different locations, i.e. immediately upstream of the pump device 2, immediately downstream of the pump device 2 and directly into the jet device 5.

The respective blowing devices 6 are connected to a distributor 9 via which one or more gas flow(s) can be individually distributed among the respective blowing devices 6. It is accordingly possible by way of the respective blowing devices 6 to add different volumes of gas, at optionally different pressures, into the respective line sections of the feed line 3.

A detector 10 communicates with the distributor 9 and detects by way of measuring instruments 11 associated with it and arranged at different locations in the line sections of the feed line 3 the size or distribution of the gas bubbles located inside the feed line 3, or rather the feed line section. The measuring instruments 11 can include by way of example optical measuring devices via which the size, or rather distribution, of the gas bubbles inside the feed line 3 can be detected.

In the present case five measuring instruments 11 are arranged along the length of the feed line 3, so the detector 10 continuously or discontinuously receives measurement data, supplied by the measuring instruments 11, relating to the size, or rather distribution, of the gas bubbles. The result of detection can be used in particular to control the distribution of the gas flow among the corresponding blowing devices 6 by the distributor 9. This means if, by way of example, it is determined at the measuring instruments 11 arranged immediately upstream of the jet device 5 that there is not enough gas in the mass flow flowing in the feed line 3, the blowing device 6 associated with the jet device 5 can be switched on and it can blow an appropriate volume of gas into the mass flow. Changes in the size of the gas bubbles, or rather in the gas bubble distribution, inside the feed line 3 can accordingly be detected by way of the detector 10, or rather the measuring instruments 11, so the blowing devices 6 can then be individually controlled, or rather regulated. Requirements, threshold values or the like stored in a storage device (not shown) associated with the detector can optionally be taken into account for this.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide V. DIRECTV, 69 USPQ2d 1865 (Fed. Cir. 2004).

1-14. (canceled)

15. A method for obtaining metal-containing valuable substances from a suspension that contains the metal-containing valuable substances, comprising:
pressurizing the suspension by passing the suspension through a pump device;
mixing the suspension with a gas after pressurizing the suspension, so as to charge the suspension with the gas;
after pressurizing the suspension, feeding the suspension to a jet device of a flotation cell via a feed line; and
separating the metal-containing valuable substances from the suspension in the flotation cell.

16. The method as claimed in claim 15, wherein the suspension is mixed with the gas directly after leaving the pump device.

17. The method as claimed in claim 15, wherein the suspension is also mixed with the gas before entering the pump device.

18. The method as claimed in claim 15, wherein at least 10% of a total volume of gas to be fed to the suspension is fed before entry of the suspension into the jet device.

19. The method as claimed in claim 15, wherein the suspension is mixed with the gas by feeding the gas to the feed line via a blowing device connected to the feed line.

20. The method as claimed in claim 15, wherein the suspension flows through the feed line at a speed of 0.5 to 5 m/s.

21. The method as claimed in claim 15, wherein the suspension flows through the feed line at a speed of 0.75 to 3 m/s.

22. The method as claimed in claim 15, wherein the suspension flows through the feed line at a speed of approximately 1 m/s.

23. The method as claimed in claim 15, wherein air and/or nitrogen is used as the gas.

24. The method as claimed in claim 15, wherein the pump device is a centrifugal pump.

25. A device to obtain metal-containing valuable substances from a suspension that contains the metal-containing valuable substances, the device comprising:
a pump device to pressurize the suspension;
a flotation cell in which the metal-containing valuable substances are separated from the suspension;
a feed line connecting the flotation cell to the pump device;
a jet device arranged between feed line and the flotation cell, to feed the suspension to the flotation cell; and
a blowing device to blow a gas into the feed line, the blowing device being positioned between the pump device and the jet device.

26. The device as claimed in claim 25, wherein the blowing device is arranged immediately downstream of the pump device.

27. The device as claimed in claim 25, wherein an additional blowing device is positioned on a line section upstream of the pump device.

28. The device as claimed in claim 25, wherein an additional blowing device is positioned on the jet device.

29. The device as claimed in claim 25, wherein
the device comprises a plurality of blowing devices, at least one of which is positioned between the pump device and the jet device, and
a distributor is arranged upstream of the plurality of blowing devices to distribute a flow of gas among the plurality of blowing devices.

30. The device as claimed in claim 29, wherein
a detector detects gas bubble size for gas bubbles flowing inside the feed line,
the detector is communicatively connected to the distributor, and
the distributor distributes the flow of gas among the plurality of blowing devices as a function of the gas bubble size detected.
